(19) United States
(12) Patent Application Publication
(10) Pub. No.: US 2017/0146834 A1
(43) Pub. Date: May 25, 2017

(54) DISPLAY DEVICE

(71) Applicant: SAMSUNG DISPLAY CO., LTD., Yongin-si (KR)

(72) Inventors: Kyung Seon TAK, Hwaseong-si (KR); Byung Chul KIM, Asan-si (KR); Jae Hong PARK, Seoul (KR); Sang Hee YU, Hwaseong-si (KR); Won Gap YOON, Suwon-si (KR); Young Joo JEON, Seoul (KR)

(21) Appl. No.: 15/169,912

(22) Filed: Jun. 1, 2016

(30) Foreign Application Priority Data
Nov. 25, 2015 (KR) 10-2015-0165166

(51) Int. Cl. G02F 1/1339; G02F 1/1343; G02F 1/1335

(52) U.S. Cl. CPC G02F 1/1339; G02F 1/133512; G02F 1/133514; G02F 1/134309; G02F 2203/01

(57) ABSTRACT

A display device includes a first base substrate in which a display area and a non-display area are defined, a first common electrode on the first base substrate in the non-display area, a light-blocking member which is disposed on the first common electrode and in which an opening exposing a part of the first common electrode is defined, a second base substrate separated from the first base substrate and facing the first base substrate, and a sealing member which is interposed between the first base substrate and the second base substrate, is disposed in the non-display area, surrounds the display area, and overlaps at least a part of the first common electrode, where the sealing member includes at least one light-blocking sealant and at least one light-transmitting sealant stacked on each other, where the light-transmitting sealant has a lower optical density than that of the light-blocking sealant.

This application claims priority to Korean Patent Application No. 10-2015-0165166, filed on Nov. 25, 2015, and all the benefits accruing therefrom under 35 U.S.C. §119, the content of which in its entirety is herein incorporated by reference.

### BACKGROUND

1. Field

Exemplary embodiments of the invention relate to a display device.

2. Description of the Related Art

A liquid crystal display (“LCD”) and an organic light-emitting display are two of the most widely used types of a flat panel display. An LCD generally includes a display panel which includes two substrates having field generating electrodes such as pixel electrodes and common electrodes and a liquid crystal layer interposed between the two substrates, for example.

In this case, a sealing member having a certain adhesive strength is used to bond the two substrates together and seal the liquid crystal layer, thereby preventing internal elements from being contaminated and damaged by a foreign matter. In this regard, it is desired to develop a sealing member which improves durability such that its adhesion to the two substrates is not reduced despite of an external impact and has a moisture-proof capability high enough to maintain a sufficient level of reliability of a display device.

A black matrix-on-array structure in which a light-blocking member is formed on an array substrate having a thin-film transistor (“TFT”) is being developed to secure an alignment margin of the two substrates.

### SUMMARY

In a conventional flat panel display, however, external impurities may permeate into a panel through a sealing member area which bonds an upper substrate and a lower substrate together, specifically, through a sealing member disposed along edges of the upper substrate and the lower substrate, thereby reducing the reliability of the display device.

In addition, as a bezel area of a display device is desired to be narrowed as much as possible, an internal pattern in a non-display area of a display panel, which is not covered by the bezel area, may be reflected by external incident light and thus visible to a viewer. This problem may worsen as the internal pattern becomes complicated.

Exemplary embodiments of the invention provide a display device whose internal pattern in a non-display area is not visible despite a narrow bezel.

Exemplary embodiments of the invention also provide a display device which may suppress the permeation of foreign impurities such as a foreign matter, oxygen and moisture and have sufficient durability against external impact.

However, exemplary embodiments of the invention are not restricted to the one set forth herein. The above and other exemplary embodiments of the invention will become more apparent to one of ordinary skill in the art to which the invention pertains by referencing the detailed description of the invention given below.

According to an exemplary embodiment of the invention, there is provided a display device including a first base substrate in which a display area and a non-display area surrounding the display area are defined, a first common electrode which is disposed on the first base substrate in the non-display area, a light-blocking member which is disposed on the first common electrode and in which an opening exposing a part of the first common electrode is defined, a second base substrate which is separated from the first base substrate to face the first base substrate, and a sealing member which is interposed between the first base substrate and the second base substrate, is disposed in the non-display area to surround the display area, and overlaps at least a part of the first common electrode, where the sealing member includes at least one light-blocking sealant and at least one light-transmitting sealant stacked on each other, where the at least one light-transmitting sealant has a lower optical density than that of the at least one light-blocking sealant.

In an exemplary embodiment, the at least one light-transmitting sealant may have a lower moisture permeability than that of the at least one light-blocking sealant.

In an exemplary embodiment, the display device may further includes a second common electrode which is disposed on the second base substrate, where the sealing member further includes at least one additional sealant which is stacked with the at least one light-blocking sealant and the light-transmitting sealant, where the additional sealant contacts the first common electrode and/or the second common electrode and has greater adhesion to the first common electrode and the second common electrode than that of the at least one light-blocking sealant and the light-transmitting sealant.

In an exemplary embodiment, the at least one light-blocking sealant may cover at least one side surface of the light-transmitting sealant, or the at least one light-transmitting sealant may cover at least one side surface of the at least one light-blocking sealant.

In an exemplary embodiment, the at least one light-transmitting sealant may be inserted into the at least one light-blocking sealant, or the at least one light-blocking sealant may be inserted into the light-transmitting sealant.

In an exemplary embodiment, the opening may completely overlap the sealing member.

In an exemplary embodiment, the sealing member may further overlap the light-blocking member.

In an exemplary embodiment, the sealing member may contact the first common electrode exposed through the opening.

In an exemplary embodiment, the display device may further include a conductive member which is located in the sealing member, and a second common electrode which is disposed on the second base substrate, where the first common electrode and the second common electrode are electrically connected by the conductive member.

In an exemplary embodiment, the display device may further include a color filter layer which is disposed between the first base substrate and the first common electrode and overlaps at least a part of the first common electrode, a passivation layer which is disposed between the color filter layer and the first base substrate, and a gate insulating layer which is disposed between the passivation layer and the first base substrate, where the first common electrode contacts at least a part of the passivation layer and at least a part of the gate insulating layer.

In an exemplary embodiment, the light-blocking sealant may have an optical density equal to or greater than about 1.5.

In an exemplary embodiment, the light-blocking sealant may include a sealant composition which includes epoxy or acrylic resin, a coupling agent, and light-blocking particles.

According to an exemplary embodiment of the invention, there is provided a display device including a first base substrate in which a display area and a non-display area surrounding the display area are defined, a first common electrode which is disposed on the first base substrate in the non-display area, a light-blocking member which is disposed on the first common electrode and in which an opening exposing a part of the first common electrode is defined, a second base substrate which is separated from the first base substrate to face the first base substrate, a light-blocking sealant which is interposed between the first base substrate and the second base substrate, is disposed in the non-display area to surround the display area, and overlaps at least a part of the first common electrode, and at least one light-transmitting sealant which is interposed between the first base substrate and the second base substrate, is disposed in the non-display area to surround the light-blocking sealant, and has a lower optical density than that of the light-blocking sealant.

In an exemplary embodiment, the light-blocking sealant may further overlap the light-blocking member.

In an exemplary embodiment, the light-blocking sealant may contact the first common electrode exposed through the opening.

In an exemplary embodiment, the display device may further include a conductive member which is located in the sealing member, and a second common electrode which is disposed on the second base substrate, where the first common electrode and the second common electrode are electrically connected by the conductive member.

In an exemplary embodiment, the display device may further include a color filter layer which is disposed between the first base substrate and the first common electrode and overlaps at least a part of the first common electrode, where a height of a top surface of the color filter layer is higher than that of a top surface of the light-blocking member in the non-display area.

In an exemplary embodiment, the light-transmitting sealant may contact the first common electrode.

In an exemplary embodiment, the light-blocking sealant may have an optical density equal to or greater than about 1.5.

In an exemplary embodiment, the light-blocking sealant may include a sealant composition which includes epoxy or acrylic resin, a coupling agent, and light-blocking particles.

A display device according to an exemplary embodiment of the invention uses a multilayer sealing member including a sealant with superior optical density. Therefore, an internal pattern in a non-display area of a display panel may be prevented from being seen from outside.

In addition, a multilayer sealing member including a sealant with a superior moisture-proof capability is used to minimize impurities that permeate into a display panel.

Further, since a multilayer sealing member has superior adhesion to upper and lower substrates, a display device having improved durability may be provided.

However, the effects of the invention are not restricted to the one set forth herein. The above and other effects of the invention will become more apparent to one of daily skill in the art to which the invention pertains by referencing the claims.

### BRIEF DESCRIPTION OF THE DRAWINGS

The above and other exemplary embodiments and features of the invention will become more apparent by describing in detail exemplary embodiments thereof with reference to the attached drawings, in which:

FIG. 1 is an exploded perspective view of an exemplary embodiment of a display device according to the invention;

FIG. 2 is a plan view of the display device of FIG. 1;

FIG. 3 is a plan view of a pixel area illustrated in FIG. 2;

FIG. 4 is a plan view of a sealing member area in a non-display area of FIG. 2;

FIG. 5 is a cross-sectional view taken along line Va-Va′ of FIG. 3 and the line Vb-Vb′ of FIG. 4;

FIG. 6 is a cross-sectional view, corresponding to FIG. 5, of another exemplary embodiment of a display device according to the invention; and

FIGS. 7 through 12 are cross-sectional views, corresponding to FIG. 5, of other exemplary embodiments of display devices according to the invention.

### DETAILED DESCRIPTION

Features of the invention and methods of accomplishing the same may be understood more readily by reference to the following detailed description of preferred embodiments and the accompanying drawings.

The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, steps, integers, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described with reference to the attached drawings.

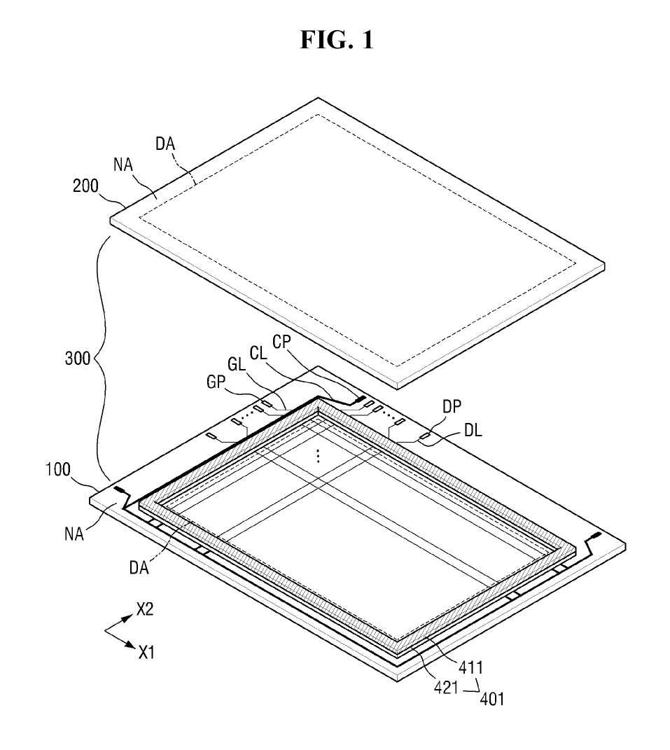

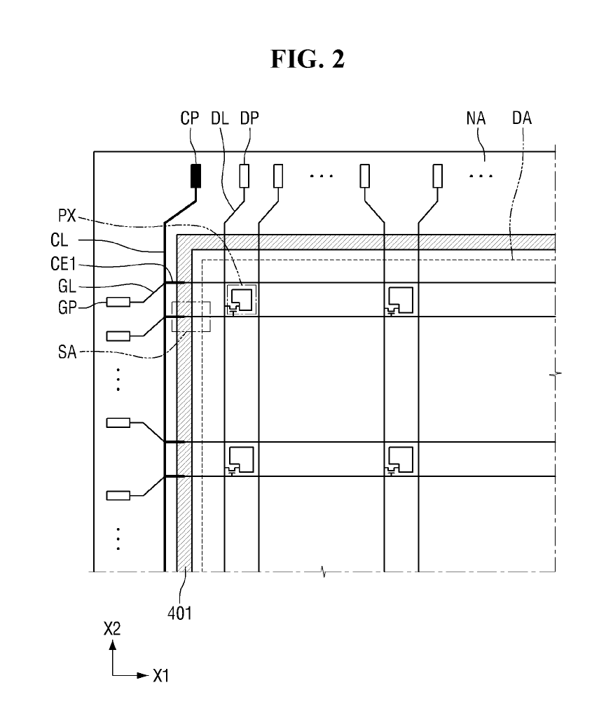

FIG. 1 is an exploded perspective view of a display device according to an exemplary embodiment of the invention. FIG. 2 is a plan view of the display device of FIG. 1.

A display panel including a first substrate 100 and a second substrate 200 is a module that displays an image. In exemplary embodiments, the display panel may be a liquid crystal display (“LCD”) panel, an electrophoretic display panel, an organic light-emitting display panel, a plasma display panel, etc., for example. An LCD will hereinafter be described as an example of the display device according to the exemplary embodiments. However, the display panel is not limited to the LCD panel, and various display panels and various display devices may be used as will be clearly understood by those of ordinary skill in the art to which the invention pertains.

Referring to FIG. 1, the display device includes the first substrate 100, the second substrate 200 which is separated from the first substrate 100 to face the first substrate 100, a liquid crystal layer 300 which is interposed between the first substrate 100 and the second substrate 200, and a sealing member 401 which is located on a peripheral part of each of the first substrate 100 and the second substrate 200 to bond the two substrates 100 and 200 together and seal the liquid crystal layer 300.

The first substrate 100 may be a lower display substrate, and the second substrate 200 may be an upper display substrate. The first substrate 100 may have a larger planar area than that of the second substrate 200. Each of the first substrate 100 and the second substrate 200 includes a display area DA and a non-display area NA. The display area DA is an area in which an image is displayed, and the non-display area NA is an area in which no image is displayed. The display area DA is surrounded by the non-display area NA.

The display area DA includes a plurality of gate lines GL extending in a first direction X1 (e.g., a row direction), a plurality of data lines DL extending in a second direction X2 (e.g., a column direction) intersecting the first direction X1, and a plurality of pixel areas PX provided at intersections of the gate lines GL and the data lines DL. The pixel areas PX may be arranged in the row direction and the column direction to provide substantially a matrix pattern. However, the invention is not limited thereto, and the pixel areas PX may provide various other types of patterns.

Each of the pixel areas PX may display one of primary colors. In an exemplary embodiment, the primary colors may be, for example, red, green, and blue. However, the invention is not limited thereto, and each of the pixel areas PX may display various other colors.

The non-display area NA may be a light-blocking area. A gate driver (not illustrated) which provides gate signals to the pixel areas PX of the display area DA and a data driver (not illustrated) which provides data signals to the pixels PX of the display area DA may be disposed in the non-display area NA of the first substrate 100 which is not overlapped by the second substrate 200. The gate lines GL and the data lines DL may extend from the display area DA to the non-display area NA and may be electrically connected to the above drivers by gate pads GP and data pads DP, respectively.

The non-display area DA further includes a common line CL which extends in the first direction X1 and/or the second direction X2 to surround the display area DA. In FIGS. 1 and 2, the common line CL surrounds three surfaces of the display area DA, for example. However, at least a part of the common line CL may also be discontinuous or may surround four surfaces of the display area DA. In addition, a voltage supply unit (not illustrated) which supplies a common voltage to the pixel areas PX or supplies power to the above drivers may be disposed in the non-display area NA of the first substrate 100. The common line CL surrounding the display area DA may branch off to be electrically connected to the voltage supply unit by common pads CP.

The first substrate 100 and the second substrate 200 are bonded together by the sealing member 401. The sealing member 401 may include a light-blocking sealant 411 and a light-transmitting sealant 421 stacked on each other. The sealing member 401 may be located in the non-display area NA of each of the first substrate 100 and the second substrate 200. In an exemplary embodiment, the sealing member 401 may be located further inside than the gate pads GP, the data pads DP and the common pads CP and shaped like a quadrilateral band which surrounds the display area DA, for example. The liquid crystal layer 300 is provided in a space sealed by the first substrate 100, the second substrate 200, and the sealing member 401. In an exemplary embodiment, the liquid crystal layer 300 may include liquid crystal molecules having negative dielectric anisotropy, for example. However, the invention is not limited thereto, and the liquid crystal layer 300 may also include liquid crystal molecules having positive dielectric anisotropy.

A backlight unit (not illustrated) is disposed under the first substrate 100 and irradiates light under the display panel including the first substrate 100 and the second substrate 200. The backlight unit may include a light source (not illustrated), a light guide plate (“LGP”) (not illustrated) which guides light emitted from the light source toward the display panel, a reflective sheet (not illustrated) which is disposed under the LGP, and one or more optical sheets (not illustrated) which are disposed on the LGP and improve luminance characteristics of light proceeding toward the display panel.

Components provided in the display area DA of the display device according to the exemplary embodiment will now be described in further detail.

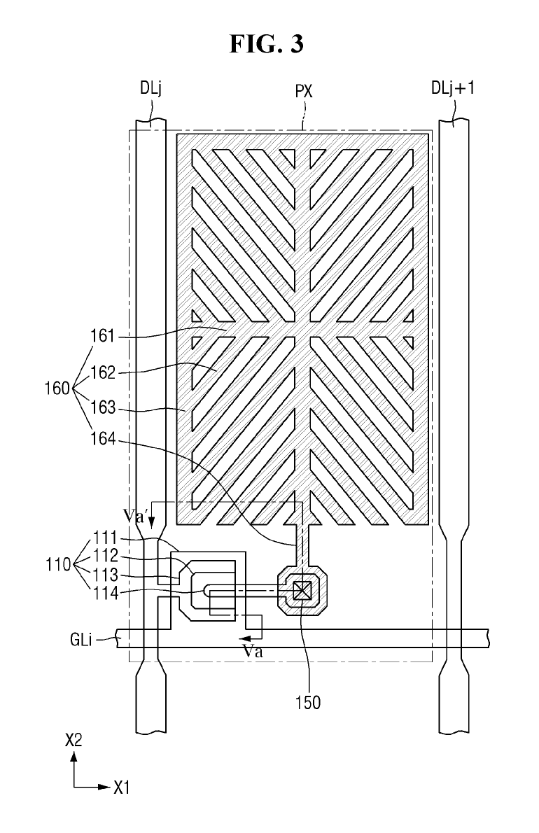

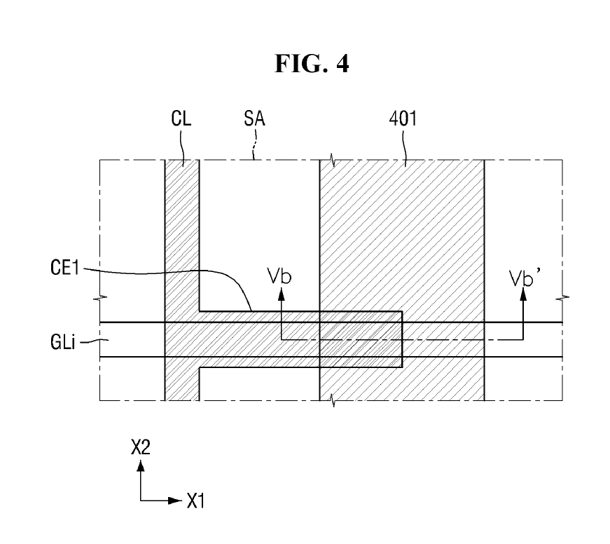

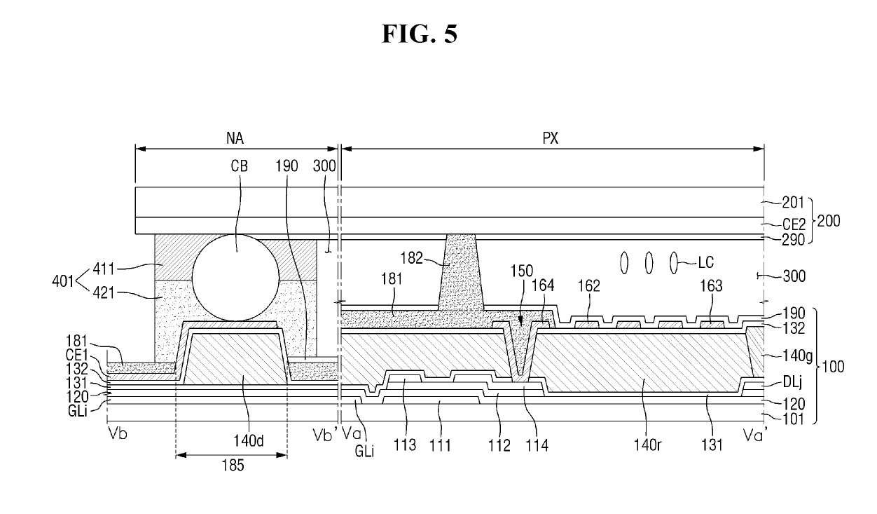

FIG. 3 is a plan view of a pixel area PX illustrated in FIG. 2. FIG. 4 is a plan view of a sealing member area SA in the non-display area NA of FIG. 2. FIG. 5 is a cross-sectional view taken along line Va-Va′ of FIG. 3 and the line Vb-Vb′ of FIG. 4.

Referring to FIGS. 3 through 5, the first substrate 100 may include a first base substrate 101, a plurality of gate lines GLi where i is a natural number equal to or greater than 1, a plurality of data lines DLj and DLj+1 where j is a natural number equal to or greater than 1, a common line including the common line CL and a first common electrode CE1, one or more thin-film transistors (“TFTs”) 110, color filters 140r and 140g, a light-blocking member 181, a column spacer 182, a pixel electrode 160, a first alignment layer 190, and a plurality of passivation/insulation layers.

The first base substrate 101 may be a transparent insulating substrate and may include a material having superior light-transmitting, heat-resistant and chemically resistant properties. In an exemplary embodiment, the first base substrate 101 may include a silicon substrate, a glass substrate, or a plastic substrate, for example.

A gate wiring layer is disposed on the display area DA and the non-display area NA of the first base substrate 101. The gate wiring layer includes the gate lines GLi and a gate electrode 111.

The gate lines GLi extend from the pixel areas PX to the non-display area NA along substantially the first direction X1. The gate electrode 111 may protrude upward from a gate line GLi. The gate electrode 111 may be integrally provided with the gate line GLi without a physical boundary therebetween and receive a gate signal from the gate line GLi. That is, the gate electrode 111 may be unitary with the gate line GLi.

The gate wiring layer may be provided by providing a gate metal thin layer and then patterning the gate metal thin layer. In an exemplary embodiment, the gate metal thin layer may include an alloy material or a compound material having an element including at least one of tantalum (Ta), tungsten (W), titanium (Ti), molybdenum (Mo), aluminum (Al), copper (Cu), silver (Ag), chrome (Cr) and neodymium (Ne) or having the element as a main component, for example. The patterning of the gate metal thin layer may be performed using a mask process or various other methods of defining a pattern.

A gate insulating layer 120 is disposed on the gate wiring layer and over the whole surface of the first base substrate 101. The gate insulating layer 120 may include an insulating material to electrically insulate a device located thereon and a device located thereunder. Examples of the material that provides the gate insulating layer 120 may include silicon nitride (SiNx), silicon oxide (SiOx), silicon nitride oxide (SiNxOy), and silicon oxynitride (SiOxNy). In an exemplary embodiment, the gate insulating layer 120 may have a multilayer structure including at least two insulating layers having different physical characteristics.

A semiconductor layer 112 is disposed on the gate insulating layer 120. At least a part of the semiconductor layer 112 may overlap the gate electrode 111. The semiconductor layer 112 may serve as a channel of a TFT and turn on or off the channel according to a voltage provided to the gate electrode 111. In an exemplary embodiment, the semiconductor layer 112 may be provided by patterning a semiconductor thin layer including a semiconducting material such as amorphous silicon, polycrystalline silicon, or oxide semiconductor, for example. In the drawings including FIG. 4, the semiconductor layer 112 is disposed in a region which overlaps a portion of a source/drain electrode 113 and 114 and a portion of the data line DLj and DLj+1 which do not overlap the gate electrode 111 by patterning the semiconductor layer 112 and a data wiring layer (which will be described later) together using a slit mask or a halftone mask. However, depending on a fabrication method, the semiconductor layer 112 may also be provided only in a region which overlaps the gate electrode 111.

The data wiring layer is disposed on the semiconductor layer 112. The data wiring layer includes the data lines DLj and DLj+1, the source electrode 113, and the drain electrode 114. The data line DLj extends along substantially the second direction X2 to intersect the gate line GLi. A pixel area PX is defined at an intersection of the data line DLj and the gate line GLi. The pixel area PX may be an area operated independently by at least one TFT 110 connected to the gate line GLi and the data line DLj.

The source electrode 113 and the drain electrode 114 are disposed on the gate electrode 111 and the semiconductor layer 112 to be separated from each other. The source electrode 113 may surround at least a part of the drain electrode 114. In an exemplary embodiment, the source electrode 113 may have a C shape, a U shape, an inverted C shape, or an inverted U shape, for example. However, the invention is not limited thereto, and the source electrode 113 may have various other shapes. The source electrode 113 may protrude to the right from the data line DLj. The source electrode 113 may be integrally provided with the data line DLj without a physical boundary and receive a data signal from the data line DLj. That is, the source electrode 113 may be unitary with the data line DLj. The drain electrode 114 may be electrically connected to the pixel electrode 160 in the pixel area PX.

The data wiring layer may be provided by providing a data metal thin layer and patterning the data metal thin layer. In an exemplary embodiment, the data metal thin layer may include a refractory metal such as silver (Ag), gold (Au), copper (Cu), nickel (Ni), platinum (Pt), palladium (Pd), iridium (Ir), rhodium (Rh), tungsten (W), aluminum (Al), tantalum (Ta), molybdenum (Mo), cadmium (Cd), zinc (Zn), iron (Fe), titanium (Ti), silicon (Si), germanium (Ge), zirconium (Zr) or barium (Ba), an alloy of these metals, or a metal nitride of these metals.

The gate electrode 111, the semiconductor layer 112, the source electrode 113, and the drain electrode 114 provide a TFT 110 which is a three-terminal switching device. Specifically, the gate electrode 111 which is a control terminal of the TFT 110 is physically connected to the gate line GLi, the source electrode 113 which is an input terminal is physically connected to the data line DLj, and the drain electrode 114 which is an output terminal is electrically connected to the pixel electrode 160.

Although not illustrated in the drawings, an ohmic contact layer (not illustrated) may further be disposed between the semiconductor layer 112 and the data wiring layer. In an exemplary embodiment, the ohmic contact layer may include an n+ hydrogenated amorphous silicon material heavily doped with an n-type impurity or may include silicide, for example.

A first passivation layer 131 may be disposed on the data wiring layer and over the whole surface of the first base substrate 101. In an exemplary embodiment, the first passivation layer 131 may include an inorganic insulating material such as silicon nitride or silicon oxide. The first passivation layer 131 may prevent wiring layers and electrodes provided thereunder from directly contacting an organic material.

A color filter layer is disposed on the first passivation layer 131. The color filter layer includes the color filter 140r or 140g disposed in the pixel area PX and a dummy color filter 140d disposed in the non-display area NA. The color filter layer may include a material that transmits light of a particular wavelength band only.

The color filter 140r may be disposed in the pixel area PX between two neighboring data lines DLj and DLj+1. Color filters which transmit light of different wavelength bands may be disposed in adjacent pixel areas PX. In an exemplary embodiment, the red color filter 140r may be disposed in a first pixel area, and the green color filter 140g may be disposed in a second pixel area adjacent to the first pixel area.

At least a part of the dummy color filter 140d may overlap the sealing member 401 of the non-display area NA. The dummy color filter 140d may be provided at the same time as a color filter in a pixel area. In an exemplary embodiment, the dummy color filter 140d may be provided at the same time as a blue color filter (not illustrated) in a third pixel area adjacent to the second pixel area, for example. In this case, the dummy color filter 140d may be a blue dummy color filter, for example. The dummy color filter 140d may provide a step with the first passivation layer 131 thereunder, thus making it easy for the first common electrode CE1 to contact a conductive member CB. In addition, when the first alignment layer 190 is coated, the dummy color filter 140d may serve as a dam that hinders the first alignment layer 190 from completely intruding into a region in which the sealing member 401 is disposed.

A second passivation layer 132 may be disposed on the color filter layer and over the whole surface of the first base substrate 101. The second passivation layer 132 may prevent a defect, such as an afterimage created during screen driving, by suppressing the contamination of the liquid crystal layer 300 due to an organic matter (e.g., a solvent) introduced from the color filter layer.

Although not illustrated in the drawings, a planarization layer (not illustrated) and/or a shielding electrode (not illustrated) may further be disposed between the color filter layer and the second passivation layer 132. The planarization layer may include an organic material and make heights of a plurality of components stacked on the first base substrate 101 equal. In addition, the shielding electrode may include a transparent metal and disposed on the data line DLj and DLj+1 to prevent the interference between electrodes due to a rapid polarity change of a data voltage or prevent liquid crystal molecules located above the data line DLj and DLj+1 from being directly affected by the data voltage.

A contact hole 150 is defined in the first passivation layer 131 and the second passivation layer 132 in the pixel area PX to expose a part of the drain electrode 114.

A patterned transparent metal layer is disposed on the second passivation layer 132. The transparent metal layer includes the pixel electrode 160 disposed in the pixel area PX and the common line CL disposed in the non-display area NA. In an exemplary embodiment, the transparent metal layer may be provided by providing a transparent metal thin layer using transparent conductive metal such as indium tin oxide or indium zinc oxide and patterning the transparent metal thin layer.

The common line CL may be disposed in the non-display area NA to receive the common voltage from the voltage supply unit (not illustrated). The common line CL may surround at least a part of the display area DA in order to efficiently deliver the common voltage received from the voltage supply unit to the display area DA. The first common electrode CE1 may branch from the common line CL toward the inside of the display panel along substantially the first direction X1 and overlap at least a part of the sealing member 401 and at least a part of the dummy color filter 140d.

The pixel electrode 160 is disposed on the drain electrode 114 exposed by the contact hole 150 and the second passivation layer 132 in the pixel area PX. The pixel electrode 160 may generate an electric field together with a second common electrode CE2 of the second substrate 200, thereby controlling the alignment direction of liquid crystal molecules LC in the liquid crystal layer 300 interposed therebeteween. In this case, a data voltage from the data line DLj may be applied to the pixel electrode 160.

In an exemplary embodiment, the pixel electrode 160 may be substantially quadrilateral and may be a patterned electrode having domain partition means, for example. Specifically, the pixel electrode 160 may include a central electrode 161, a plurality of branch electrodes 162 which extend from the central electrode 161, a slit pattern which is located between adjacent branch electrodes 162, an edge electrode 163 which connects ends of at least some of the branch electrodes 162, and a protruding electrode 164 which protrudes downward.

The central electrode 161 may be located in substantially in a center portion of the pixel area PX and may be cross (+)-shaped. The branch electrodes 162 may extend radially from the cross-shaped central electrode 161 in a sloping direction, e.g., in a direction at an angle of approximately 45 degrees to the central electrode 161. The slit pattern is defined between every two adjacent branch electrodes 162. That is, the pixel electrode 160 is divided by the central electrode 161 into a plurality of domains in which the branch electrodes 162 and the slit pattern have different directions. The domains serve as directors of the liquid crystal molecules LC, thus causing the liquid crystal molecules LC to tilt in different directions. Accordingly, this may improve liquid crystal controllability, increase a viewing angle, reduce a texture, and improve a transmittance and a response speed. The ends of at least some of the branch electrodes 162 extending radially may be connected to each other by the edge electrode 163. In addition, the protruding electrode 164 having a large area may protrude downward from the pixel electrode 160 toward the contact hole 150 to stably contact the drain electrode 114 through the contact hole 150.

The above disposition and shape of the pixel electrode 160 are merely an example. In some embodiments, some components may be added or omitted, or the pixel electrode 160 may be bent with respect to the gate line GLi and the data line DLj. In an alternative exemplary embodiment, the pixel electrode 160 may include a plurality of subpixels, for example, a first subpixel electrode to which a relatively high voltage is applied and a second subpixel electrode to which a relatively low voltage is applied.

The light-blocking member 181 may be disposed on the first transparent metal layer. In an exemplary embodiment, the light-blocking member 181 may be a black matrix including a black organic polymer material that includes black dye or pigment or a metal material such as chrome or chrome oxide.

The light-blocking member 181 is disposed in a region of the pixel area PX in which effective light transmission does not occur. Specifically, the light-blocking member 181 may be disposed in a boundary region between adjacent pixel areas PX to overlap the gate line GLi and the data line DLj and prevent the mixing of colors and the leakage of light which may occur at a boundary between the adjacent pixel areas PX. Since the light-blocking member 181 is disposed on the first substrate 100, it is possible to prevent a reduction in aperture ratio due to misalignment of the first substrate 100 and the second substrate 200.

In addition, the light-blocking member 181 is disposed in the non-display area NA and, an opening 185 exposing a part of the first common electrode CE1 which protrudes due to the step provided by the dummy color filter 140d is defined in the light-blocking member 181. In this case, a maximum height of a top surface of the dummy color filter 140d may be greater than that of a top surface of the light-blocking member 181 in the non-display area NA. Accordingly, this may prevent the leakage of light in an edge portion of the display panel and secure a surface at which the second common electrode CE1 may stably contact the conductive member CB.

The column spacer 182 may be disposed on a portion of the light-blocking member 181. The column spacer 182 is designed to maintain a distance between the first substrate 100 and the second substrate 200. The column spacer 182 may prevent a stain from being generated or a particular color from standing out due to the distortion of a pre-designed cell gap caused by external pressure. The column spacer 182 may include the same material as that of the light-blocking member 181 and may be integrally provided with the light-blocking member 181 without a physical boundary therebetween. In an exemplary embodiment, after a block matrix composition is provided, a patterning process may be performed using a slit mask or a halftone mask, thereby simultaneously providing the light-blocking member 181 and the column spacer 182 having different heights.

At least one column spacer 182 may be disposed in each pixel area PX. In an alternative exemplary embodiment, the column spacer 182 may be omitted from some pixel areas. In the drawings including FIG. 5, an end of the column spacer 182 contacts the second common electrode CE2 at the top (at the bottom in the drawing) of the second substrate 200. However, the end of the column spacer 182 may also be separated from the second substrate 200 by a predetermined distance, or a predetermined alignment layer may be interposed between the end of the column spacer 182 and the second common electrode CE2. In an alternative exemplary embodiment, a plurality of column spacers having different heights may be provided.

The first alignment layer 190 is disposed on the light-blocking member 181 and over the whole surface of the first base substrate 101 to induce the vertical alignment of the liquid crystal molecules LC in the liquid crystal layer 300. The first alignment layer 190 may be a polyimide- or polyamic acid-based vertical alignment layer having a vertical alignment group introduced to a side chain thereof. In addition, at least a part of the first alignment layer 190 may overlap the sealing member 401 inside the dummy color filter 140d and may not overlap the sealing member 401 outside the dummy color filter 140d. However, the invention is not limited thereto.

The second substrate 200 includes a second base substrate 201, the second common electrode CE2, a second alignment layer 290, etc.

Like the first base substrate 101, the second base substrate 201 may be a transparent insulating substrate. The second common electrode CE2 is disposed on the second base substrate 201. Like the pixel electrode 160, the second common electrode CE2 may be a transparent electrode. The second common electrode CE2 may overlap most of the display area DA except for some regions. As described above, the second common electrode CE2 generates an electric field together with the pixel electrode 160 of the first substrate 100, thereby controlling the alignment direction of the liquid crystal molecules LC in the liquid crystal layer 300 interposed therebetween. In this case, the common voltage provided from the voltage supply unit (not illustrated) through the common pads CP may be delivered to the second common electrode CE2 by the common line CL, the first common electrode CE1 which branches from the common line CL, and the conductive member CB which contacts the first common electrode CE1. The second alignment layer 290 may be disposed on the second common electrode CE2 and over the whole surface of the second base substrate 201. The second alignment layer 290 may include the same material as that of the first alignment layer 190, and thus a detailed description thereof is omitted.

The sealing member 401 is located in the non-display area NA of each of the first substrate 100 and the second substrate 200 to bond the first substrate 100 and the second substrate 200 together and seal the liquid crystal layer 300. The sealing member 401 may be shaped like a quadrilateral band which extends along the first direction X1 and the second direction X2 to surround the display area DA. At least one conductive member CB may be disposed in the sealing member 401 to electrically connect the first common electrode CE1 thereunder and the second common electrode CE2 thereon. The conductive members CB may be, for example, a conductive ball. However, the invention is not limited thereto, and sealants that provide the sealing member 401 may include a conductive material.

The sealing member 401 includes at least one light-transmitting sealant 421 and the light-blocking sealant 411 which includes a different material from the light-transmitting sealant 421 and disposed on the light-transmitting sealant 421. In FIG. 5, the light-blocking sealant 411 is stacked on the light-transmitting sealant 421. However, the sealing member 401 may also have a structure in which at least one light-blocking sealant and a light-transmitting sealant are stacked on each other. In the specification, a structure in which a light-transmitting sealant and a light-blocking sealant are stacked on each other denotes a structure in which the light-blocking sealant is stacked on the light-transmitting sealant and a structure in which the light-transmitting sealant is stacked on the light-blocking sealant. In some embodiments, the sealing member 401 may have a structure in which a light-transmitting sealant is disposed on a light-blocking sealant or a structure in which multiple layers of light-blocking sealants and multiple layers of light-transmitting sealants are stacked on each other. The sealing member 401 may be provided using a first syringe which includes a light-transmitting sealant composition and a second syringe which follows the first syringe and includes a light-blocking sealant composition.

The sealing member 401 may overlap a part of the first common electrode CE1 of the first substrate 100, completely overlap the opening 185 to remove a exposed surface of the first common electrode CE1, further overlap a part of the light-blocking member 181 of the non-display area NA, or further overlap a part of the first alignment layer 190. In addition, the sealing member 401 may further overlap a part of the second common electrode CE2 of the second substrate 200 or a part of the second alignment layer 290.

Specifically, the light-transmitting sealant 421 may directly contact the first common electrode CE1 which protrudes due to the step provided by the dummy color filter 140d and is exposed by the opening 185 of the light-blocking member 181 and/or directly contact the light-blocking member 181 in the non-display area NA.

The light-transmitting sealant 421 may be provided by coating and curing a sealant composition, but the invention is not limited thereto. In an exemplary embodiment, the sealant composition includes, based on total weight of the sealant composition, approximately 50 weight percent (wt %) to approximately 80 wt % of epoxy or acrylic resin, approximately 0.1 to approximately 3 wt % of a coupling agent, approximately 0.01 wt % to approximately 5 wt % of initiator, approximately 1 wt % to approximately 7 wt % of a curing agent, approximately 5 wt % to approximately 40 wt % of filler, and the balance of solvent.

The resin may make up most of a sealant or a sealant composition used to provide the sealant. Therefore, the resin may serve as a dispersion medium that causes various materials contained in the resin to be dispersed. The resin may also cause the sealant to have certain elasticity.

In addition, the sealant composition including the coupling agent, the initiator, the hardener, etc. may itself have certain adhesive strength. The sealant may be coated and then cured by heat treatment or light irradiation, thereby bonding the first substrate 100 and the second substrate 200 together.

The filler contained in the light-transmitting sealant 421 may be silica particles, acrylic particles, etc. The filler may effectively prevent the introduction of external impurities, such as moisture and air, into the light-transmitting sealant 421. The light-transmitting sealant 421 may have a lower moisture permeability or greater adhesion to the first and second common electrodes CE1 and CE2 than that of the light-blocking sealant 411. In an exemplary embodiment, the permeability of moisture into the light-transmitting sealant 421 through side surfaces of the light-transmitting sealant 421 may be equal to or less than approximately 90 grams per square meter per day (g/m²/day) or equal to or less than approximately 82 g/m²/day, for example. Since the sealing member 401 surrounding the display area DA of the display panel includes the light-transmitting sealant 421 having a superior lateral moisture-proof capability, the introduction of a foreign matter into the sealing member 401 may be effectively suppressed.

The light-blocking sealant 411 may directly contact the second common electrode CE2. The light-blocking sealant 411 may be provided by coating and curing a sealant composition, but the invention is not limited thereto. In an exemplary embodiment, the sealant composition may include, based on total weight of the sealant composition, approximately 50 wt % to approximately 70 wt % of epoxy or acrylic resin, approximately 0.1 wt % to approximately 3 wt % of a coupling agent, approximately 0.01 wt % to approximately 4 wt % of initiator, approximately 0.5 wt % to approximately 5 wt % of a curing agent, approximately 0.5 wt % to approximately 5 wt % of curing accelerator, approximately 20 wt % to approximately 40 wt % of filler, and the balance of solvent, for example. The types of one or more materials (e.g., the type of the resin) contained in the light-blocking sealant 411 may be identical or different from those of the materials contained in the light-transmitting sealant 421.

Examples of the filler contained in the light-blocking sealant 411 may include light-blocking particles and acrylic particles. The particles may prevent the introduction of external impurities into the light-transmitting sealant 411 and have high optical density. The light-blocking sealant 411 may have higher optical density and lower transmittance than that of the light-transmitting sealant 421. In an exemplary embodiment, the optical density of the light-blocking sealant 411 may be equal to or greater than approximately 1.5, equal to or greater than approximately 2.0, or equal to or less than approximately 5.0, for example. When the light-blocking sealant 411 has an optical density equal to or greater than approximately 1.5, the transmittance of the light-blocking sealant 411 may be maintained low enough to bring about a light-shielding effect. When the light-blocking sealant 411 has an optical density equal to or less than approximately 5.0, the adhesive strength of the sealant and the durability of the sealant after being cured may be secured.

In an exemplary embodiment, the light-blocking particles may be black particles such as carbon black. However, the invention is not limited thereto, and various particles that may bring about a light-blocking effect may be used. In an exemplary embodiment, oxide particles such as zirconium oxide or titanium oxide or particles having a metal core and an oxide shell may be used.

In a region of the first substrate 100 in which the first common electrode CE1 is exposed by the opening 185 of the light-blocking member 181, external light incident through the non-display area NA may be reflected by the metallic conductive member CB or the metallic first common electrode CE1, and the reflected light may be visible to a viewer. In an alternative exemplary embodiment, the opening 185 of the light-blocking member 181 and/or a repetitive fine pattern may be visible from outside the display panel. In a cross-section perpendicular to a direction in which the sealing member 401 extends, the light-blocking sealant 411 having an optical density equal to or greater than approximately 1.5 may overlap the opening 185 and the exposed first common electrode CE1 thereunder, thereby absorbing/blocking external light incident through the non-display area DA and light reflected by the first common electrode CE1.

In addition, even when the light-blocking sealant 411 and the light-transmitting sealant 421 include different materials and thus provide a physical boundary therebetween, when the types of materials and content ratios of compositions contained in the light-blocking sealant 411 and the light-transmitting sealant 421 are identical or similar, the permeation of moisture through an interface between the light-blocking sealant 411 and the light-transmitting sealant 421 may not substantially occur.

Hereinafter, display devices according to other embodiments of the invention will be described. In order to not obscure the point of the invention, a description of components substantially identical or similar to those of the display device according to the previous embodiment will be omitted as will be clearly understood from the attached drawings by those of ordinary skill in the art to which the invention pertains.

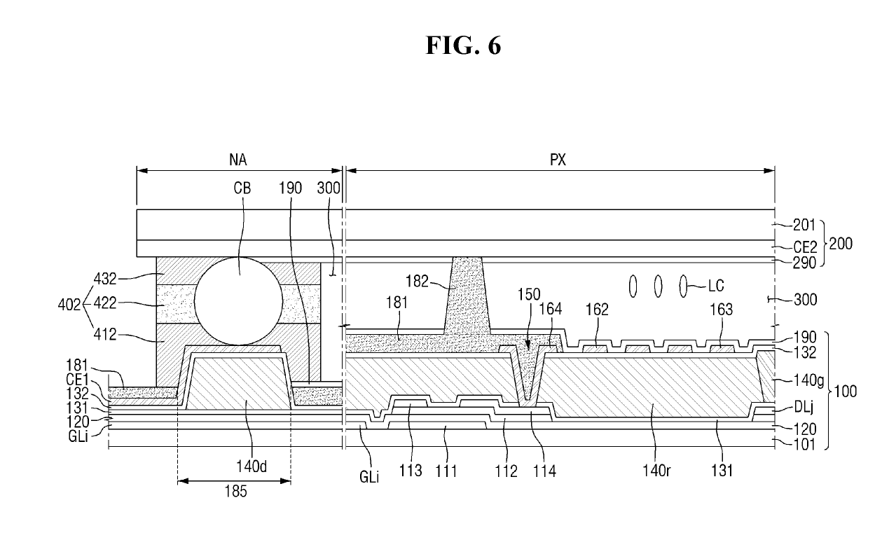

FIG. 6 is a cross-sectional view, corresponding to FIG. 5, of a display device according to another exemplary embodiment of the invention.

Referring to FIG. 6, a sealing member 402 includes a light-blocking sealant 412, a light-transmitting sealant 422 which is disposed on the light-blocking sealant 412, and an additional sealant 432 which includes a different material from the light-transmitting sealant 422 and disposed on the light-transmitting sealant 422. In some embodiments, the additional sealant 432 may be located at the bottom of the sealing member 402 or may be provided in a plurality of layers.

The additional sealant 432 may be provided by coating and curing a sealant composition, but the invention is not limited thereto. In an exemplary embodiment, the sealant composition may include, based on total weight of the sealant composition, approximately 50 wt % to approximately 70 wt % of epoxy or acrylic resin, approximately 0.1 wt % to approximately 3 wt % of a coupling agent, approximately 0.01 wt % to approximately 4 wt % of initiator, approximately 0.5 wt % to approximately 5 wt % of a curing agent, approximately 0.5 wt % to approximately 5 wt % of curing accelerator, approximately 20 wt % to approximately 40 wt % of filler, and the balance of solvent, for example. Examples of the filler contained in the additional sealant 432 may include light-blocking particles and acrylic particles. In an exemplary embodiment, the optical density of the additional sealant 432 may be equal to or greater than approximately 1.5, equal to or greater than approximately 2.0, or equal to or less than approximately 5.0, for example. The light-blocking sealant 412 and the additional sealant 432 may be identical or different. Since the additional sealant 432 having higher optical density than that of the light-transmitting sealant 422 is stacked at the top of the sealing member 402, the light-transmitting sealant 422 may be prevented from being seen from outside. In addition, the light-blocking sealant 412 may absorb/block light incident through a non-display area DA and light reflected by a first common electrode CE1.

Furthermore, the additional sealant 432 may have greater adhesion to a transparent metal layer which provides the first common electrode CE1 or a second common electrode CE2 than that of the light-transmitting sealant 422 and/or the light-blocking sealant 412, thereby improving durability by the sealing member 402.

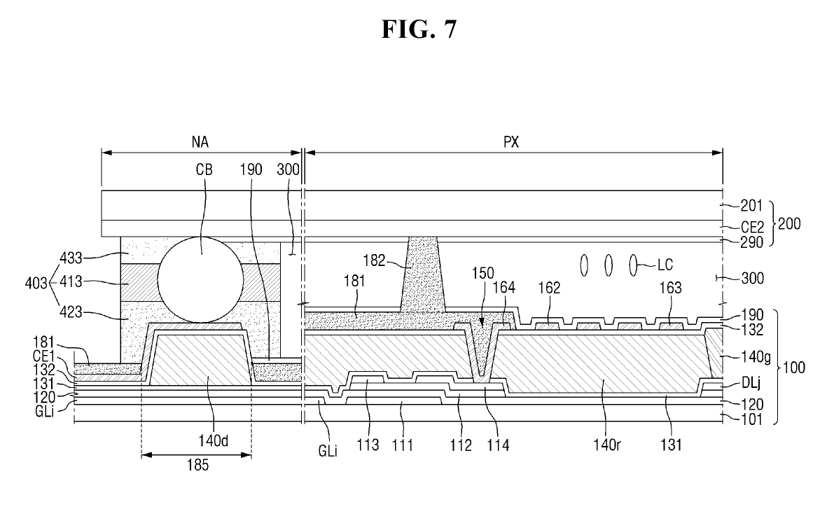

FIGS. 7 through 12 are cross-sectional views, corresponding to FIG. 5, of display devices according to other embodiments of the invention.

Referring to FIG. 7, a sealing member 403 includes a light-transmitting sealant 423, a light-blocking sealant 413 which is disposed on the light-transmitting sealant 423, and an additional sealant 433 which includes a different material from the light-blocking sealant 413 and disposed on the light-blocking sealant 413. The additional sealant 433 and the light-transmitting sealant 423 may be identical or different.

The additional sealant 433 may have greater adhesion to a transparent metal layer which provides a first common electrode CE1 or a second common electrode CE2 than that of the light-transmitting sealant 423 and/or the light-blocking sealant 413, thereby improving durability by the sealing member 403.

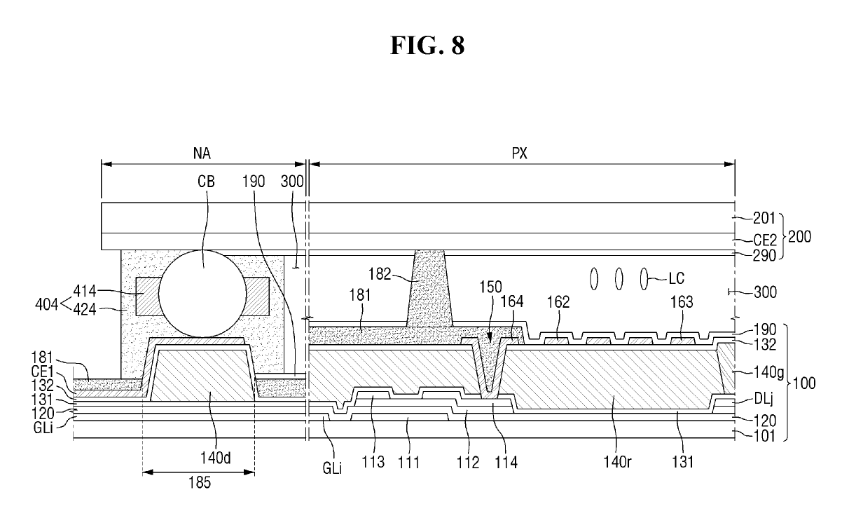

Referring to FIG. 8, the exemplary embodiment of FIG. 8 is different from the exemplary embodiment of FIG. 5 in that a light-blocking sealant 414 of a sealing member 404 is inserted into a light-transmitting sealant 424. In some embodiments, the light-transmitting sealant 424 may be inserted into the light-blocking sealant 414, unlike in FIG. 8. In an exemplary embodiment, the sealing member 404 may be provided using, e.g., a double nozzle, i.e., an inner nozzle which includes a light-blocking sealant composition and an outer nozzle which includes a light-transmitting sealant composition.

In this case, the light-blocking sealant 414 may overlap a part of a first common electrode CE1 of a first substrate 100, completely overlap an opening 185, further overlap a part of a light-blocking member 181 of a non-display area NA, or further overlap a part of a first alignment layer 190. In addition, the light-transmitting sealant 424 may directly contact the first common electrode CE1 which protrudes due to a step provided by a dummy color filter 140d and is exposed by the opening 185 of the light-blocking member 181 and/or directly contact the light-blocking member 181 in the non-display area NA. Further, the light-transmitting sealant 424 may directly contact a second common electrode CE2.

Since the light-blocking sealant 414 is inserted into the light-transmitting sealant 424, only the light-transmitting sealant 424 having a relatively lower moisture permeability than that of the light-blocking sealant 414 may contact the outside. In addition, since an interface between the light-blocking sealant 414 and the light-transmitting sealant 424 is covered with the light-transmitting sealant 424, the total moisture-proof capability of the sealing member 404 may be improved.

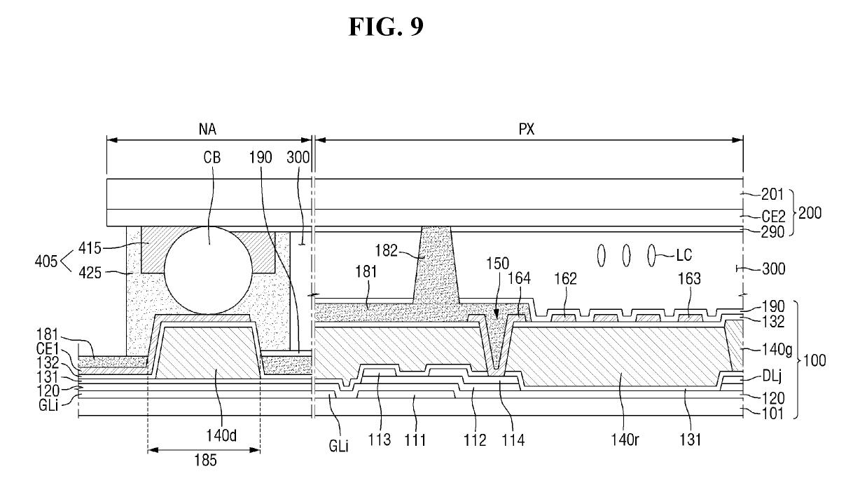

Referring to FIG. 9, the exemplary embodiment of FIG. 9 is different from the exemplary embodiment of FIG. 5 in that a light-transmitting sealant 425 covers at least one side surface of a light-blocking sealant 415. In some embodiments, the light-blocking sealant 415 may cover at least one side surface of the light-transmitting sealant 425, or a combination of the above two cases may be used.

In this case, the light-blocking sealant 415 of a sealing member 405 may overlap a part of a first common electrode CE1 of a first substrate 100, completely overlap an opening 185, further overlap a part of a light-blocking member 181 of a non-display area NA, or further overlap a part of a first alignment layer 190. In addition, the light-transmitting sealant 425 may directly contact the first common electrode CE1 which protrudes due to a step provided by a dummy color filter 140d and is exposed by the opening 185 of the light-blocking member 181 and/or directly contact the light-blocking member 181 in the non-display area NA. Further, the light-blocking sealant 415 and the light-transmitting sealant 425 may directly contact a second common electrode CE2.

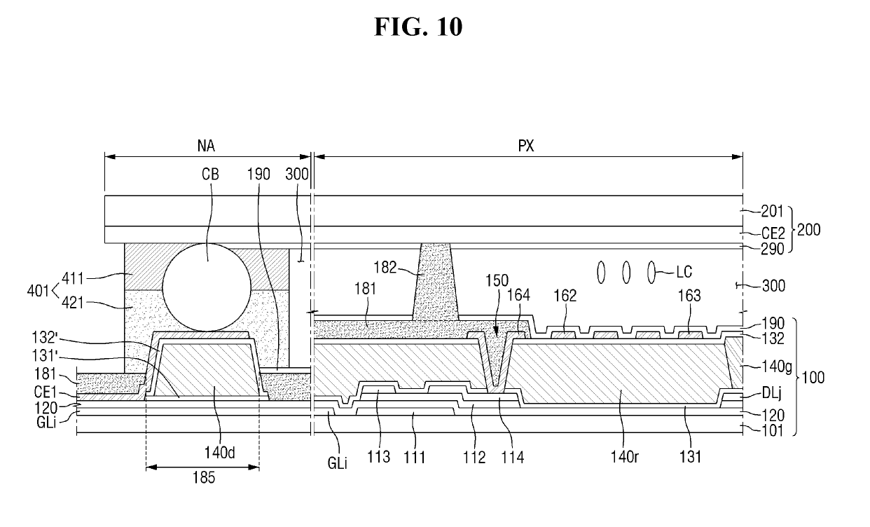

Referring to FIG. 10, the exemplary embodiment of FIG. 10 is different from the exemplary embodiment of FIG. 5 in that a first passivation layer 131′ and a second passivation layer 132′ in a non-display area NA are partially removed such that a first common electrode CE1 directly contacts a side surface of the first passivation layer 131′ and a gate insulating layer 120.

In this case, the first passivation layer 131′ and the second passivation layer 132′ in the non-display area NA may be removed when a contact hole 150 is defined in a pixel area PX. At least one of both ends of each of the first passivation layer 131′ and the second passivation layer 132′ in the non-display area NA may overlap a sealing member 401, but the invention is not limited thereto.

Since the first passivation layer 131′ and the second passivation layer 132′ are partially removed such that the first common electrode CE1 contacts a side surface of the first passivation layer 131′ and the gate insulating layer 120, interlayer interfaces exposed at an edge of a side surface of a display panel may be minimized. That is, the formation of interfaces other than an interface between the first common electrode CE1 and the gate insulating layer 120 may be prevented, thereby minimizing the permeation of a foreign matter, such as moisture or air, through interlayer interfaces.

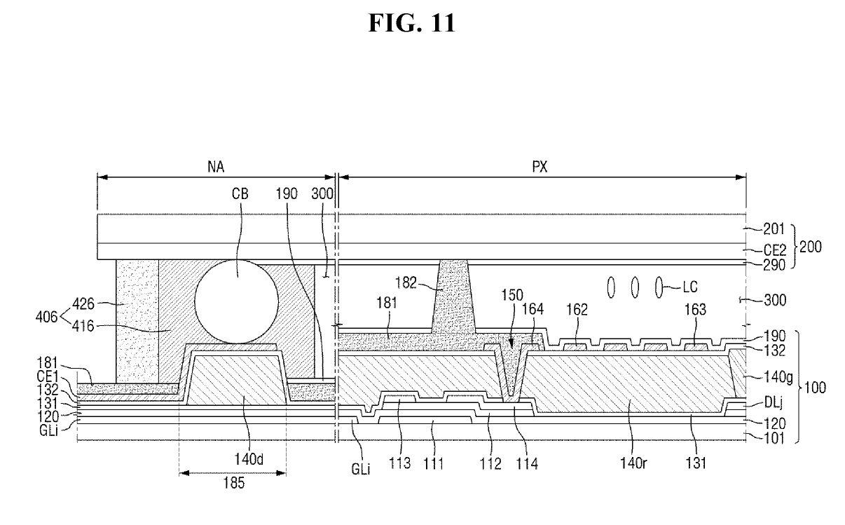

Referring to FIG. 11, a sealing member 406 includes a light-blocking sealant 416 and a light-transmitting sealant 426. The light-transmitting sealant 426 has a lower optical density than that of the light-blocking sealant 416, contacts a side surface of the light-blocking sealant 416, and is located relatively further outside than the light-blocking sealant 416 to surround the light-blocking sealant 416 when seen from above. In some embodiments, one or more additional sealants which contact a side surface of the light-blocking sealant 416 and/or a side surface of the light-transmitting sealant 426 may further be provided.

The light-blocking sealant 416 may overlap a part of a first common electrode CE1 of a first substrate 100, completely overlap an opening 185, further overlap a part of a light-blocking member 181 of a non-display area NA, or further overlap a part of a first alignment layer 190. In addition, the light-blocking sealant 416 may overlap a part of a second common electrode CE2 of a second substrate 200 or further overlap a part of a second alignment layer 290.

Specifically, the light-blocking sealant 416 may directly contact the first common electrode CE1 which protrudes due to a step provided by a dummy color filter 140d and is exposed by the opening 185 of the light-blocking member 181 and/or directly contact the light-blocking member 181 in the non-display area NA. Further, the light-blocking sealant 416 may directly contact the second common electrode CE2.

The light-transmitting sealant 426 may contact a side surface of the light-transmitting sealant 416 and overlap the light-blocking member 181. In addition, the light-transmitting sealant 426 may directly contact the light-blocking member 181 and the second common electrode CE2 in the non-display area NA.

Since the light-transmitting sealant 426 having a relatively lower moisture permeability than that of the light-blocking sealant 416 surrounds the light-blocking sealant 416, the permeation of a foreign matter, such as moisture or air, into a display panel may be minimized.

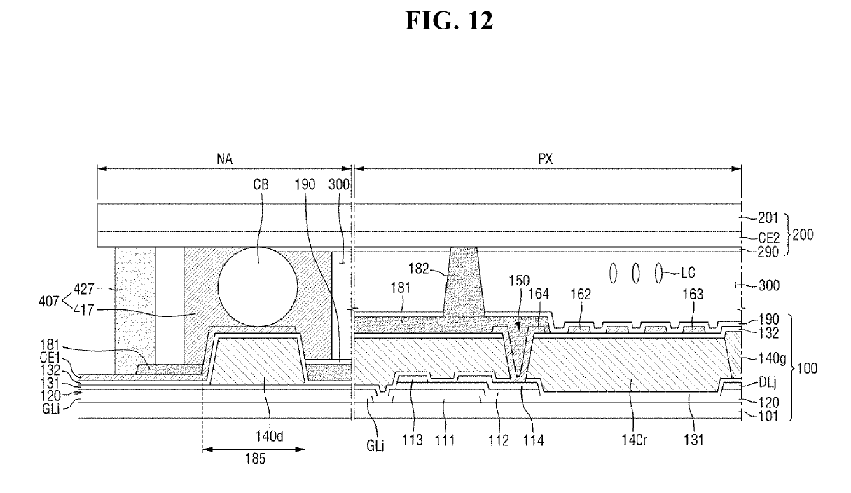

Referring to FIG. 12, the exemplary embodiment of FIG. 12 is different from the exemplary embodiment of FIG. 11 in that a light-blocking sealant 417 and a light-transmitting sealant 427 are separated apart to define a space therebetween. The space may be, for example, an air layer. The air layer may minimize the permeation of a foreign matter, such as moisture or air, through a side surface of a sealing member 407.

In this case, the light-transmitting sealant 427 may directly contact a part of a light-blocking member 181 of a non-display area NA and contact a first common electrode CE1. Accordingly, an interface between the light-blocking member 181 and the first common electrode CE1 which is exposed at an edge of a side surface of a display panel may be removed, and the permeation of a foreign matter, such as moisture or air, through the interface may be minimized.

While exemplary embodiments have been shown and described above, it will be apparent to those skilled in the art that modifications and variations could be made without departing from the spirit and scope of the invention as defined by the appended claims. The exemplary embodiments should be considered in a descriptive sense only and not for purposes of limitation.

What is claimed is:

1. A display device comprising:
a first base substrate in which a display area and a non-display area surrounding the display area are defined;
a first common electrode which is disposed on the first base substrate in the non-display area;
a light-blocking member which is disposed on the first common electrode and in which an opening exposing a part of the first common electrode is defined;
a second base substrate which is separated from the first base substrate and faces the first base substrate; and
a sealing member which is interposed between the first base substrate and the second base substrate, is disposed in the non-display area, surrounds the display area, and overlaps at least a part of the first common electrode,
wherein the sealing member comprises at least one light-blocking sealant and at least one light-transmitting sealant stacked on each other, wherein the at least one light-transmitting sealant has a lower optical density than that of the at least one light-blocking sealant.

2. The display device of claim 1, wherein the at least one light-transmitting sealant has a lower moisture permeability than that of the at least one light-blocking sealant.

3. The display device of claim 1, further comprising a second common electrode which is disposed on the second base substrate, wherein the sealing member further comprises at least one additional sealant which is stacked with the at least one light-blocking sealant and the at least one light-transmitting sealant, wherein the additional sealant contacts the first common electrode and/or the second common electrode and has greater adhesion to the first common electrode and the second common electrode than that of the at least one light-blocking sealant and the at least one light-transmitting sealant.

4. The display device of claim 1, wherein the at least one light-blocking sealant covers at least one side surface of the at least one light-transmitting sealant, or the at least one light-transmitting sealant covers at least one side surface of the at least one light-blocking sealant.

5. The display device of claim 4, wherein the at least one light-transmitting sealant is inserted into the at least one light-blocking sealant, or the at least one light-blocking sealant is inserted into the at least one light-transmitting sealant.

6. The display device of claim 1, wherein the opening completely overlaps the sealing member.

7. The display device of claim 6, wherein the sealing member further overlaps the light-blocking member.

8. The display device of claim 1, wherein the sealing member contacts the first common electrode exposed through the opening.

9. The display device of claim 8, further comprising:
a conductive member which is located in the sealing member; and
a second common electrode which is disposed on the second base substrate,
wherein the first common electrode and the second common electrode are electrically connected by the conductive member.

10. The display device of claim 8, further comprising:
a color filter layer which is disposed between the first base substrate and the first common electrode and overlaps at least a part of the first common electrode;
a passivation layer which is disposed between the color filter layer and the first base substrate; and
a gate insulating layer which is disposed between the passivation layer and the first base substrate,
wherein the first common electrode contacts at least a part of the passivation layer and at least a part of the gate insulating layer.

11. The display device of claim 1, wherein the at least one light-blocking sealant has an optical density equal to or greater than about 1.5.

12. The display device of claim 1, wherein the at least one light-blocking sealant includes a sealant composition which comprises epoxy or acrylic resin, a coupling agent, and light-blocking particles.

13. A display device comprising:
a first base substrate in which a display area and a non-display area surrounding the display area are defined;
a first common electrode which is disposed on the first base substrate in the non-display area;
a light-blocking member which is disposed on the first common electrode and in which an opening exposing a part of the first common electrode is defined;
a second base substrate which is separated from the first base substrate and faces the first base substrate;
a sealing member which is interposed between the first base substrate and the second base substrate;
a light-blocking sealant which is interposed between the first base substrate and the second base substrate, is disposed in the non-display area, surrounds the display area, and overlaps at least a part of the first common electrode; and
at least one light-transmitting sealant which is interposed between the first base substrate and the second base substrate, is disposed in the non-display area, surrounds the light-blocking sealant, and has a lower optical density than that of the light-blocking sealant.

14. The display device of claim 13, wherein the light-blocking sealant further overlaps the light-blocking member.

15. The display device of claim 13, wherein the light-blocking sealant contacts the first common electrode exposed through the opening.

16. The display device of claim 15, further comprising:
a conductive member which is located in the sealing member; and
a second common electrode which is disposed on the second base substrate,
wherein the first common electrode and the second common electrode are electrically connected by the conductive member.

17. The display device of claim 15, further comprising a color filter layer which is disposed between the first base substrate and the first common electrode and overlaps at least a part of the first common electrode, wherein a height of a top surface of the color filter layer is higher than that of a top surface of the light-blocking member in the non-display area.

18. The display device of claim 13, wherein the at least one light-transmitting sealant contacts the first common electrode.

19. The display device of claim 13, wherein the light-blocking sealant has an optical density equal to or greater than about 1.5.

20. The display device of claim 13, wherein the light-blocking sealant includes a sealant composition which comprises epoxy or acrylic resin, a coupling agent, and light-blocking particles.
